(19) United States
(12) Patent Application Publication
(10) Pub. No.: US 2004/0154843 A1
(43) Pub. Date: Aug. 12, 2004

(54) Device for receiving a force acting upon a vehicles seat

(76) Inventors: Andreas Aumer, Regensburg (DE); Ulrich Deml, Lappersdorf (DE); Karl-Heinz Eglseder, Maxhutte (DE); Manfred Frimberger, Ergoldsbach (DE)

Correspondence Address: MORRISON & FOERSTER LLP, 1650 TYSONS BOULEVARD, SUITE 300, MCLEAN, VA, 22102, US

(21) Appl. No.: 10/468,734

(22) PCT Filed: Jan. 25, 2002
(86) PCT No.: PCT/DE02/00262

(30) Foreign Application Priority Data
Feb. 23, 2001 (DE) 101 08 822.1
Mar. 23, 2001 (DE) 101 14 312.5

(51) Int. Cl. G01G 13/14; G01G 23/14

(52) U.S. Cl. 177/165

(57) ABSTRACT

The invention relates to a device for receiving a force applied to a seat, particularly a vehicle seat. Said device comprises at least one spring element (5) for elastically positioning the seat in such a way that the seat support components (1,2,3,4) are coupled together by means of the spring element (5). The inventive device also comprises a sensor which detects the spring excursion or an alteration of the spring excursion or a position of the spring element.

The invention relates to a device for detecting a force acting on a seat, specifically a vehicle seat.

In the field of occupant protection in motor vehicles, ascertaining the occupant weight is becoming increasingly important, the occupant weight and possibly also the weight distribution over the vehicle seat being suitable variables for co-determining that the occupant is “out of position”. If the occupant has adopted an out-of-position posture, complete inflation of the airbag can do the occupant more harm than good. Such out-of-position scenarios occur, for example, when the occupant leans right forward with his head directly in front of the airbag's outlet opening. Also at particular risk are small, light persons who, because of their stature, sit close up to the steering wheel and may be put at risk in the event of a sudden airbag deployment. Ascertaining the occupant weight is mainly required in combination with optical or other means of occupant position detection in order to determine whether one or more stages of a multistage airbag have to be activated, thereby enabling the risk of injury to the occupant to be minimized.

Mats provided with electrical structures incorporated in the seat pad and which vary their electrical resistance under the effect of weight have frequently been proposed.

Incorporating a mat of this kind in a vehicle seat is extremely expensive. The electrical connection of such a mat is also complex.

DE 38 09 074 A1 discloses a device wherein pressure sensors mounted on the seat support components carrying the seat pad and the seat backrest indicate any change in weight, a front- and a rear-mounted compressive force measuring sensor being provided on each seat rail.

Generally strain gauges, capacitive or piezoelectric elements for detecting pressure variations are used.

The disadvantage of a measuring device of this kind is that very small deformations in the existing seat structure have to be sensed. Displacement variations in the μ-range constitute a problem in terms of resolution of the measurement signal.

With a view to using the measuring device over the service life of the vehicle, the measuring arrangement must also be protected from overload. However, for this purpose mechanical stops would have to be manufactured in the several μm range in the case of the known measuring device.

With the known measuring device, geometrical variations caused by temperature effects have the same order of magnitude as the measured variable. The known measuring device therefore requires a means of compensating such temperature effects.

All the components used must have low tolerances. Components having these low mechanical tolerances are expensive.

The object of the present invention is therefore to specify a device for registering a force acting on a seat which ensures a good resolution and is not susceptible to malfunction.

This invention is achieved by the features detailed in claim 1.

In the existing seat structure there is additionally incorporated a spring element which interconnects seat support components. The seat with seat pad and backrest attached to the seat support structure is therefore resiliently mounted. There is provided a sensor which detects the deflection of the spring element or a change in the spring deflection or a position of the spring element.

Seat support components are essentially seat structures which support the seat with its seat pad and backrest, i.e. specifically a mounting base for the seat—in the case of a vehicle seat this is generally the floor pan of the vehicle body—, seat rails for fore and aft adjustment of the seat, the seat frame connecting the seat to the seat rails and sliding in the seat rails, or seat cross-braces for accommodating the seat pad or backrest.

The spring element according to the invention is incorporated in the “seat—seat rail—mounting base” force path in such a way that it yields resiliently as soon as a force, and in particular a weight force exerted by an object or an occupant on the seat, acts upon said seat.

The spring element has a large deflection and therefore supplies a significant signal. The weight as a force quantity is determined by measuring the deflection/deformation of the spring element. Proportionality preferably exists between the variables of force and deflection.

The spring element has a defined spring constant so that a certain deformation of the spring element represents a certain weight force acting on the spring element.

The spring element is compliant in a defined manner in response to weight load transmitted via seat support components, and returns to its original position when the weight load is removed.

Through use and suitable dimensioning, when the vehicle seat is occupied a spring deflection is produced which permits a very good resolution of the forces to be determined.

A spring deflection caused by temperature variation is negligible compared to a spring deflection caused by the effect of force.

As the mechanical power=force×velocity is great, a large electrical signal is also to be expected. The mechanical construction is torque free with respect to input and output line when the force to be measured is applied. Mechanical tolerances of the interfaces (seat, seat suspension, chassis) therefore have no or only minimal effect.

Components require no extremely high tolerance accuracy, which means that the device can be manufactured inexpensively. A standard sensor can also be used as the sensing element for measuring the spring deflection. The displacement measurement is technically feasible and also industrializable.

Advantageous further developments of the invention are detailed in the sub-claims.

The spring deflection is preferably greater than or equal to 0.1 mm at maximum excursion of the spring element, specifically greater than or equal to 0.5 mm and approximately 1 mm for a particularly good resolution.

The maximum excursion is specifically less than 5 mm.

These dimensional specifications for the maximum excursion of the spring element satisfy the requirements in terms of adequate signal resolution on the one hand and minimal impairment of occupant comfort on the other. An excessively large maximum excursion would result in the occupant experiencing oscillatory movements caused by the spring element, which is undesirable. Excessively large maximum excursions additionally result in a large overall height which may in turn involve increasing the passenger compartment dimensions. Excessively small maximum excursions, on the other hand, do not provide the required resolution in the measurement signal.

At a maximum excursion of the spring element of ±1 mm, a distance traveled by the spring element of 1/100 mm can be resolved, which corresponds, for example, to a weight load of 1 kg at a spring constant of 10⁶ N/m. The weight can therefore be measured to within one kg accuracy.

The spring element with associated sensor can preferably be disposed between a seat rail and a mounting base as seat support components. A spring element with associated sensor is then preferably provided at each support point between seat rail and mounting base, i.e. preferably 4 spring element/sensor arrangements at the ends of the seat rails between seat rail and mounting base.

As a further development, the spring element with sensor can be disposed between seat and seat rail, again preferably at each support point, i.e. a total of 4 spring element/sensor arrangements between seat and seat rail, a spring element preferably connecting a seat frame (3) supporting the seat and displaceably mounted in the seat rail (2) to a seat cross-brace (4), or connecting one component of the seat frame to another component of the seat frame.

The invention and its further developments will now be explained in greater detail with reference to exemplary embodiments in the accompanying drawings:

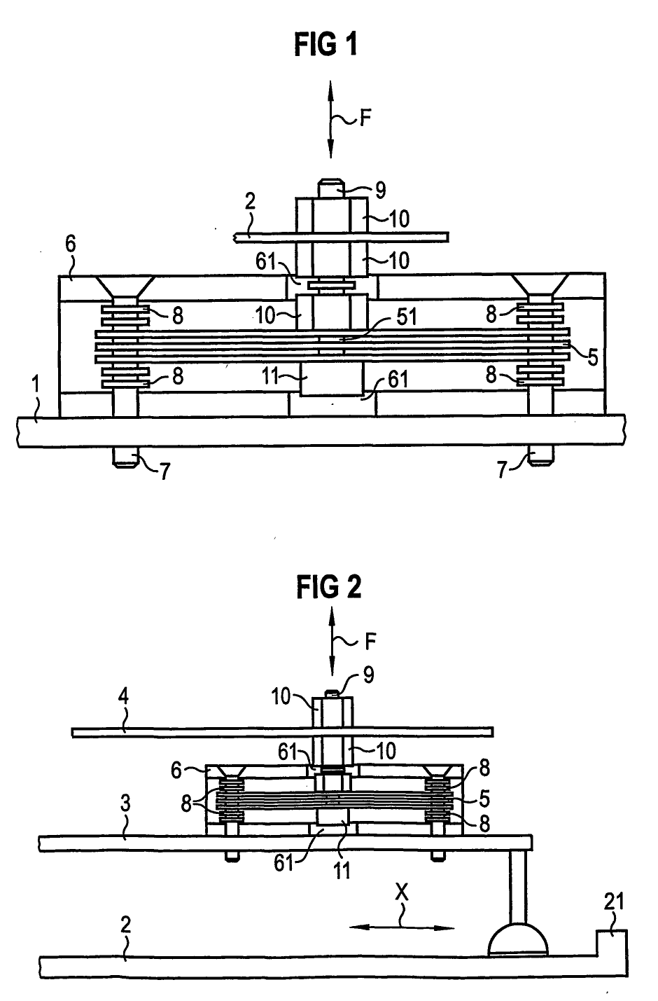

FIG. 1 shows a first exemplary embodiment of the invention in cross-section;

FIG. 2 shows another exemplary embodiment of the invention in cross-section.

FIG. 1 shows a device for detecting a force F acting on a seat.

Only a small detail of a seat support structure at one end of a seat rail 2 is shown in cross-section here. In FIG. 1 the seat rail 2 ends on the right-hand side and is connected via a spring element 5 to a mounting base 1 which itself is only partly illustrated in its lateral extent.

The spring element 5 is enclosed by a housing 6. The housing 6 is preferably a hollow section body. The housing 6 protects the spring element 5 and in particular the sensor described below.

Drilled holes 61 in the housing 6 permit a screw connection between the seat rail 2 and the spring element 5, a fastening screw 9 being fed through the hole 61. Two nuts 10 fix the seat rail 2 to the fastening screw 9, another nut 10 and a stop 11 implemented as a nut in turn fix the spring element 5 to the fastening screw 9.

In the exemplary embodiment the spring element 5 is a steel spring in the form of a laminated spring with a plurality of leaves which can also be seen from FIG. 1. However, single-leaf spring steel can also be used.

Alternatively other types of spring such as a spiral spring, for example, can also be used.

At its ends the spring element 5 is connected by fastening screws 7 to the mounting base 1. When the device is used for a vehicle seat, the mounting base is a vehicle body component, namely the vehicle floor.

For the attachment of the spring element 5 to the mounting base 1, spacers 8 are provided which, possibly together with housing components, hold the spring element 5 sufficiently far above the mounting base 1 that the maximum required or possible excursion of the spring element 5 in the direction of the mounting base 1 is ensured.

When a force F is applied to the device, here for example a compressive force F, in the direction of the mounting base 1, the rigid coupling between the seat rail 2 and the spring element 5 causes the latter to be likewise deflected downward towards the mounting base 1 in the direction of the arrow, the spring steel being the compliant spring element which permits excursions in the mm range as a function of the force acting thereon in the direction of the arrow. Because of its edge fixation by the fastening screws 7, the spring element 5 exhibits maximum deflection at its center, this location being indicated by reference character 51. In FIG. 1 admittedly no force is applied to the spring element 5 which is seen in its neutral position.

At this location of maximum excursion 51 in relation to the width of the spring element there is also preferably provided a suitable sensor for determining the absolute position of the spring element 5, or for determining the spring deflection, or for determining a change in the spring deflection. The sensor can be based on different physical principles. For example, a Hall sensor, LVDT (Linear Variable Differential Transformer), potentiometer, etc. can be used. The sensor can be noncontacting or operate in contact with the spring element 5. Detection of the position of the spring steel by the sensor in relation to the housing 6 enables the applied force F to be inferred using the known force-displacement assignment.

In order to protect the measuring device from overload, the nut for securing the spring element 5 to the fastening screw 9 is implemented as a stop 11. If an excessive force F acts on the arrangement, the stop 11 strikes the housing 6 or the mounting base 1. An increase in the force F does not produce any further deflection of the spring steel, thereby preventing possible damage. This mechanical design consequently acts as overload protection. Overload protection is preferably also provided for tensile stress.

For use of the arrangement in a motor vehicle for determining a force acting on a vehicle seat, a plurality of these arrangements according to FIG. 1 should preferably be provided, preferably an identically constructed coupling of the rail to the mounting base via another spring element being likewise provided. This means that the seat rail is resiliently mounted on the vehicle body, with two support points at the ends of the seat rail. The further seat rail for the vehicle seat is supported in the same way. A vehicle seat (not shown) comprising a seat pad and a backrest is preferably attached to a seat frame running in the two seat rails so that the vehicle seat is displaceably mounted in the seat rails.

If a force is applied to the vehicle seat in the direction of the arrow as shown in FIG. 1, e.g. by the weight force of an object or a person, the force is transmitted to the two seat rails via the seat and the seat frame. Because of the aforementioned resilient mounting of the seat rails in relation to the mounting base/vehicle body, the spring elements are deflected. This excursion is measured using the associated sensors. By computing the four sensor signals provided in this case, the force acting on the seat, at least in the vertical direction, can be inferred.

In some cases it is also possible to determine the force distribution on the vehicle seat. If for example a heavy object is placed in the front area of the seat, only the two spring elements disposed at the front ends of the seat rails are deflected in the direction of the mounting base. The two spring elements disposed at the back ends of the seat rails, on the other hand, are subjected to tensile stress and deflected in the opposite direction. This sensor configuration allows inferences to be drawn regarding the weight distribution on the vehicle seat.

For a weight force calculation of this kind, the following have still to be worked out as interference variables: the weight force of the seat and of the seat frames and rails themselves; transient force variations due to weight shifts, etc.

FIG. 2 shows another exemplary embodiment of the invention in a cross-sectional view.

The same elements are identified by the same reference characters as in FIG. 1.

Again, only a small detail of a seat support structure at one end of a seat rail 2 is shown in cross-section. In FIG. 2, the seat rail 2 ends on the right-hand side with a seat rail stop 21 for a seat frame 3. The seat-supporting frame 3 is displaceably mounted in the x-direction in the seat rail 2. The seat frame 3 is often referred to in technical circles as the seat pan.

The seat rail 2 fixed to a mounting base (not shown). The seat frame 3 is connected to a seat cross-brace 4. The seat cross-brace in turn supports the seat pad and the rest of the seat construction. The coupling between seat frame 3 and seat cross-brace 4 is via a spring element 5. The characteristics of the spring element 5, housing 6 and all the other resilient mounting components are as described in FIG. 1. According to FIG. 2, only the seat cross-brace 4 instead of the seat rail 2 from FIG. 1 is now connected to the spring element 5, and the seat frame 3 instead of the mounting base 1 from FIG. 1 is connected to the housing 6.

The spring element as shown in FIG. 2 is therefore disposed at another location in the force path within the seat support structure, but can at this location likewise reliably register the weight force acting on the seat.

For use of the arrangement in a motor vehicle for determining a force acting on a vehicle seat, a plurality of these arrangements according to FIG. 2 should preferably be provided, an identically constructed coupling of the seat cross-brace to the seat frame via another spring element preferably being likewise provided at the left-hand end (not shown) of the seat frame. This means that the seat is resiliently mounted on the seat frame, with two support points at the ends of the seat frame. The other side of the seat frame which engages in the other seat rail is likewise provided with spring elements at its ends.

With regard to determining the force distribution and calculating weight variables taking interference factors into account, the details with reference to FIG. 1 correspondingly apply.

What is claimed is:

1. Device for detecting a force acting on a seat, specifically a vehicle seat,
having at least one spring element (5) for resilient mounting of the seat in such a way that seat support components (1,2,3,4) are interconnected via the spring element (5), and
having a sensor for detecting the spring deflection or a change in the spring deflection or in a position of the spring element,
characterized in that the spring element (5) at maximum excursion exhibits a spring deflection of equal to or greater than 0.2 mm.

2. Device according to claim 1,
wherein the spring element (5) at maximum excursion exhibits a spring deflection of equal to or greater than 0.5 mm.

3. Device according to one of the preceding claims,
wherein the spring element (5) at maximum excursion exhibits a spring deflection of equal to or greater than 1 mm.

4. Device according to one of the preceding claims,
wherein the spring element (5) contains a steel spring.

5. Device according to one of the preceding claims,
wherein the spring element (5) is disposed in a housing (6).

6. Device according to one of the preceding claims,
wherein a stop (11) is provided which prevents deformation of the spring element (5) beyond a defined extent.

7. Device according to one of the preceding claims,
wherein the spring element (5) is connected to a seat rail (2) in which the seat is displaceably mounted and to a mounting base (1).

8. Device according to claim 7,
wherein each seat rail (2) assigned to the seat is connected to the mounting base (1) via a separate spring element (5).

9. Device according to claim 7 or claim 8,
wherein the seat rail (2) is fixed to the spring element (5), and the housing (6) is fixed to the mounting base (1).

10. Device according to one of the preceding claims,
wherein the spring element (5) is connected to a first component of a seat frame (3) supporting the seat and displaceably mounted in the seat rail (2) and to a second component of said seat frame (3).

11. Device according to one of the preceding claims,
wherein the spring element (5) is connected to a seat frame (3) supporting the seat and displaceably mounted in the seat rail (2) and to a seat cross-brace (4).
